(19) United States
(12) Patent Application Publication
(10) Pub. No.: US 2025/0322352 A1
(43) Pub. Date: Oct. 16, 2025

(54) METHOD FOR TRACKING AND UPDATING PRODUCT DATA FOR SLOTS IN INVENTORY STRUCTURES WITHIN A STORE

(71) Applicant: Simbe Robotics, Inc., South San Francisco, CA (US)

(72) Inventors: Bradley Bogolea, South San Francisco, CA (US); Jariullah Safi, South San Francisco, CA (US); Kanchan Bahirat, South San Francisco, CA (US)

(21) Appl. No.: 19/175,635

(22) Filed: Apr. 10, 2025

Related U.S. Application Data
(60) Provisional application No. 63/632,476, filed on Apr. 10, 2024.

(51) Int. Cl. G06Q 10/087; G06Q 30/0251; G06V 10/25; G06V 20/56

(52) U.S. Cl. CPC G06Q 10/087; G06Q 30/0268; G06V 10/25; G06V 20/56

(57) ABSTRACT

One variation of a method includes: accessing an image of an inventory structure captured by a robotic system while navigating through a store; detecting a slot in the inventory structure in the image; based on features extracted from the image, identifying a set of product units of a first product type occupying the slot; accessing a target product type assigned to the slot by a store representation; based on features extracted from the image, identifying an electronic shelf label depicted in the image, corresponding to the slot, and advertising the target product type; and, in response to the first product type differing from the target product type assigned to the slot, accessing a set of product data corresponding to the first product type from a product database, and, transmitting the set of product data to the electronic shelf label for rendering within an electronic display of the electronic shelf label.

### CROSS-REFERENCE TO RELATED APPLICATIONS

This Application claims the benefit of U.S. Provisional Application No. 63/632,476, filed on 10 Apr. 2024, which is incorporated in its entirety by this reference.

### TECHNICAL FIELD

This invention relates generally to the field of stock tracking and, more specifically, to a new and useful method for tracking and updating product data for slots in inventory structures within a store in the field of stock tracking.

### BRIEF DESCRIPTION OF THE FIGURES

FIGS. 1A and 1B are flowchart representations of a method;

FIG. 2 is a flowchart representation of one variation of the method;

FIG. 3 is a flowchart representation of one variation of the method;

FIG. 4 is a flowchart representation of one variation of the method;

FIGS. 5A and 5B are flowchart representations of one variation of the method;

FIG. 6 is a flowchart representation of one variation of the method; and

FIG. 7 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Alternate Product in Slot

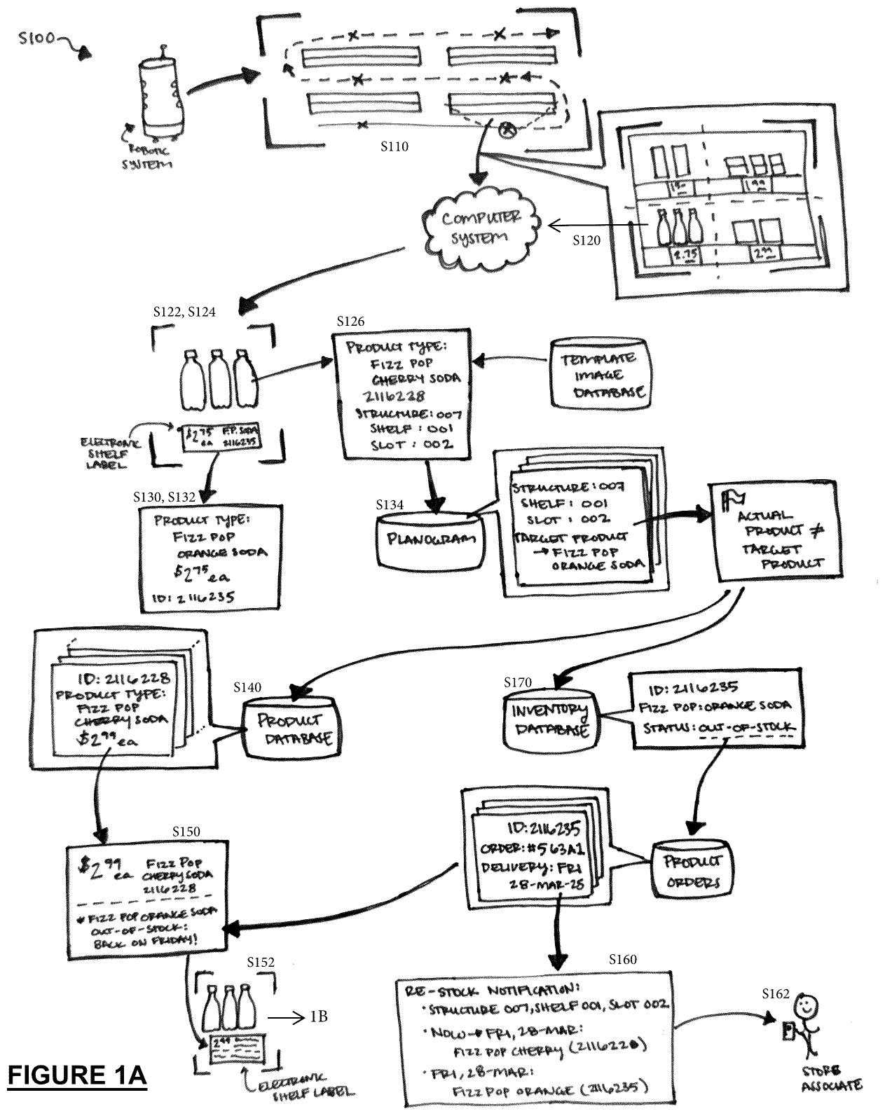

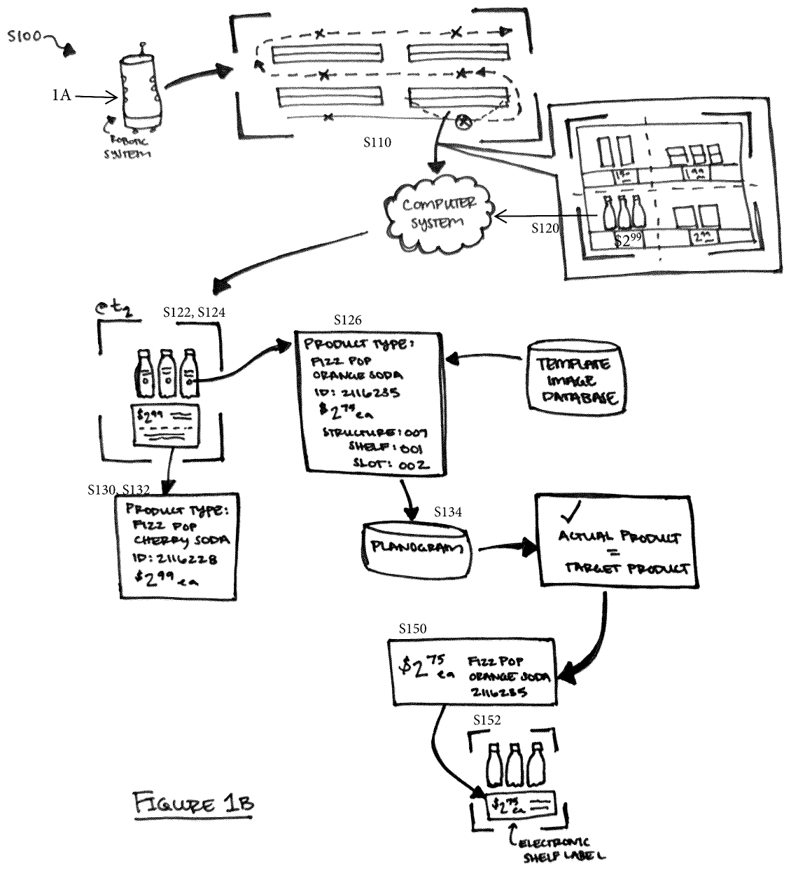

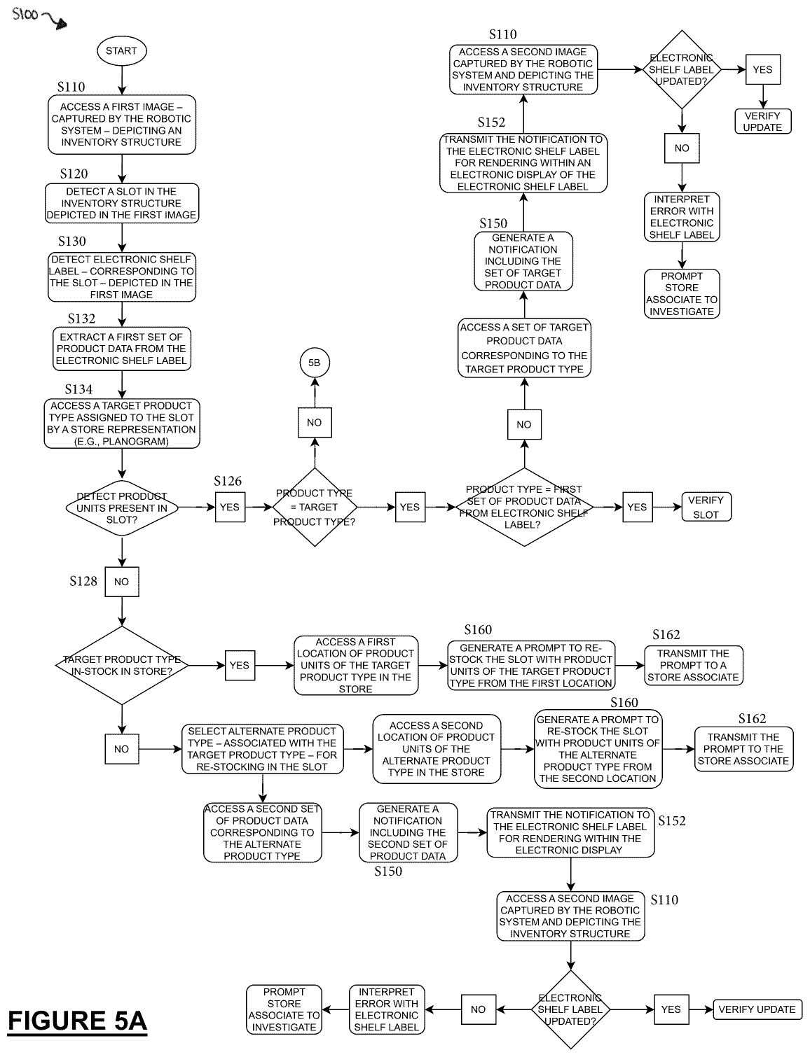

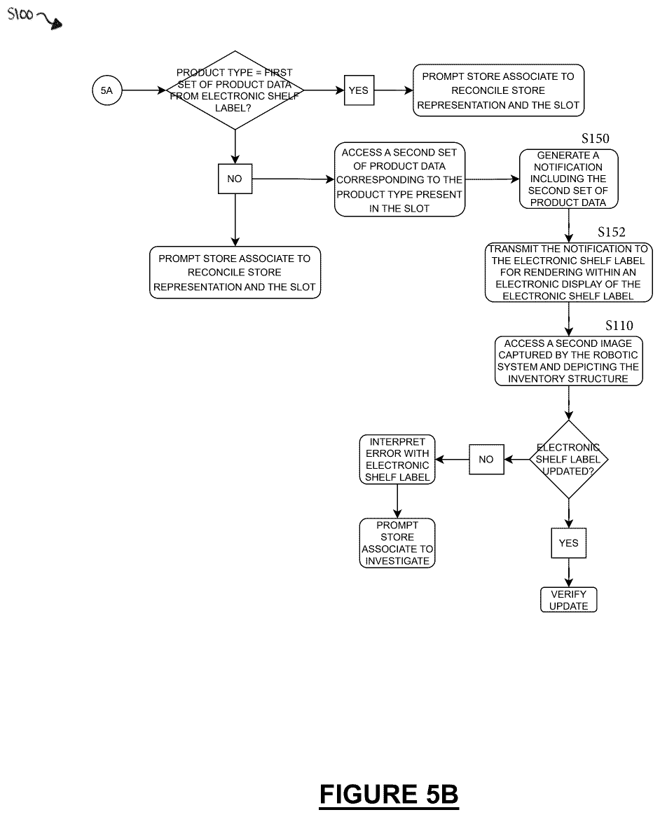

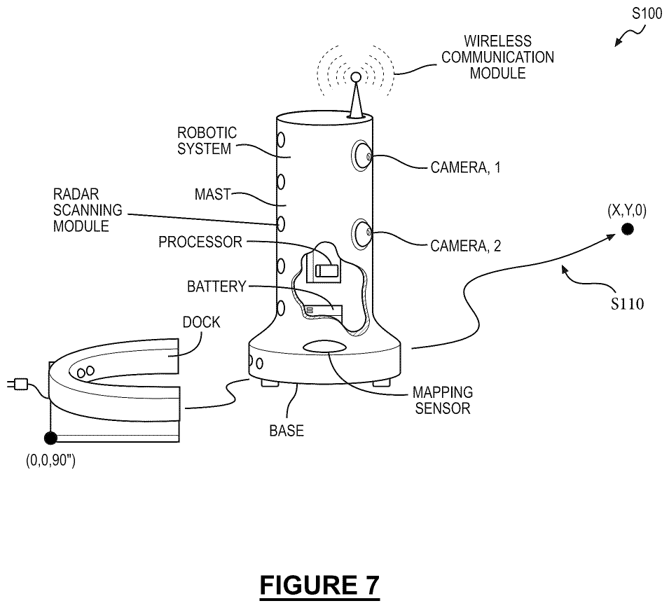

As shown in FIGS. 1A, 1B, 2, 5A, 5B, and 7, a method S100 includes: accessing an image of an inventory structure captured by a robotic system while navigating through a store, the inventory structure defining a set of slots in Block Silo; detecting a first slot, in the set of slots, within the inventory structure in the image in Block S120; detecting a first set of objects occupying the first slot in the image in Block S122; extracting a first set of features from a first region of the image representing the first set of objects in Block S124; based on the first set of features, identifying a first set of product units of a first product type occupying the first slot in Block S126; detecting a first object in a first lateral position in the image, the first lateral position below the first slot; extracting a second set of features from a second region of the image representing the first object; based on the second set of features, identifying a first electronic shelf label depicted in the second region of the image in Block S130; and accessing a target product type assigned to the first slot by a graphical representation of the store in Block S134. The method S100 further includes, in response to the first product type differing from the target product type assigned to the first slot: extracting a first set of product data from the second region of the image, the first set of product data corresponding to the target product type and rendered within an electronic display of the first electronic shelf label in Block S132; accessing a second set of product data from a product database defined for the store, the second set of product data corresponding to the first product type of the first set of product units occupying the first slot in Block S140; generating a first notification including the second set of product data in Block S150; and transmitting the first notification to the first electronic shelf label for rendering within the electronic display of the first electronic shelf label in Block S152.

In one variation, the method S100 includes: accessing an image of an inventory structure captured by a robotic system while navigating through a store, the inventory structure defining a set of slots in Block Silo; detecting a first slot, in the set of slots, within the inventory structure in the image in Block S120; detecting a first set of objects occupying the first slot in the image in Block S122; extracting a first set of features from a first region of the image representing the first set of objects in Block S124; based on the first set of features, identifying a first set of product units of a first product type occupying the first slot in Block S126; accessing a target product type assigned to the first slot by a graphical representation of the store in Block S134; detecting a first object in a first lateral position in the image, the first lateral position below the first slot; extracting a second set of features from a second region of the image representing the first object; based on the second set of features, identifying a first electronic shelf label depicted in the second region of the image in Block S130; and extracting a first set of product data from the second region of the image, the first set of product data corresponding to the target product type and rendered within an electronic display of the first electronic shelf label in Block S132. In this variation, the method S100 further includes, in response to the first product type differing from the target product type assigned to the first slot and advertised by the first electronic shelf label: accessing a second set of product data from a product database defined for the store, the second set of product data corresponding to the first product type of the first set of product units occupying the first slot in Block S140; generating a first notification including the second set of product data in Block S150; and transmitting the first notification to the first electronic shelf label for rendering within the electronic display of the first electronic shelf label in Block S152.

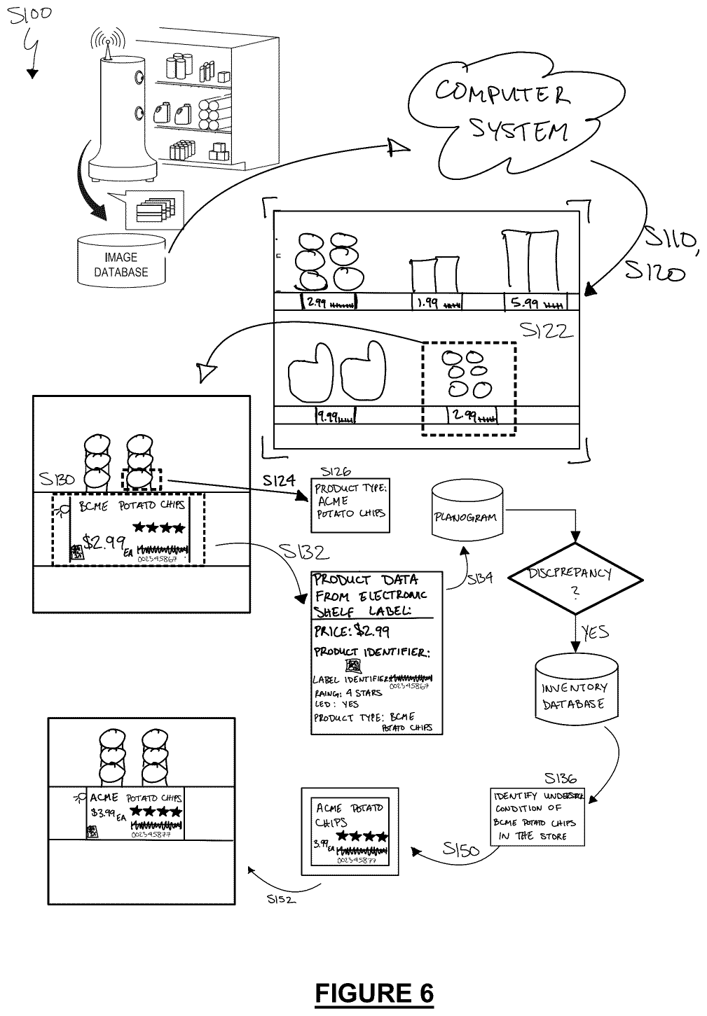

In one variation, as shown in FIGS. 1A, 1B, 5A, 5B, 6, and 7, the method S100 for tracking and updating product data for slots in inventory structures within a store includes: accessing an image of an inventory structure captured by a robotic system while navigating through a store in Block Silo; detecting a first slot, in a set of slots in the inventory structure, depicted in the image in Block S120; detecting a first set of product units occupying the first slot, in the set of slots, depicted in the image in Block S122; extracting a first set of features from a first region of the image in Block S124; based on the first set of features, identifying a product type of the first set of product units in Block S126; identifying an electronic shelf label, arranged below the first slot in the set of slots, depicted in a second region of the image in Block S130; and extracting a first set of product data from the second region of the image in Block S132.

The method S100 further includes, accessing a target product type assigned to the first slot, in the set of slots, by a planogram of the store in Block S134 and, in response to detecting a discrepancy between the first product type and the target product type: accessing an understock condition of product units, of the target product type, in the store from an inventory database in Block S136; generating an electronic notification indicating the current product type based on the understock condition in Block S150; and transmitting the electronic notification to the electronic shelf label to render on an integrated display of the electronic shelf label in Block S152.

### 1.1 Variation: Empty Slot+Live Electronic Shelf Label Updates

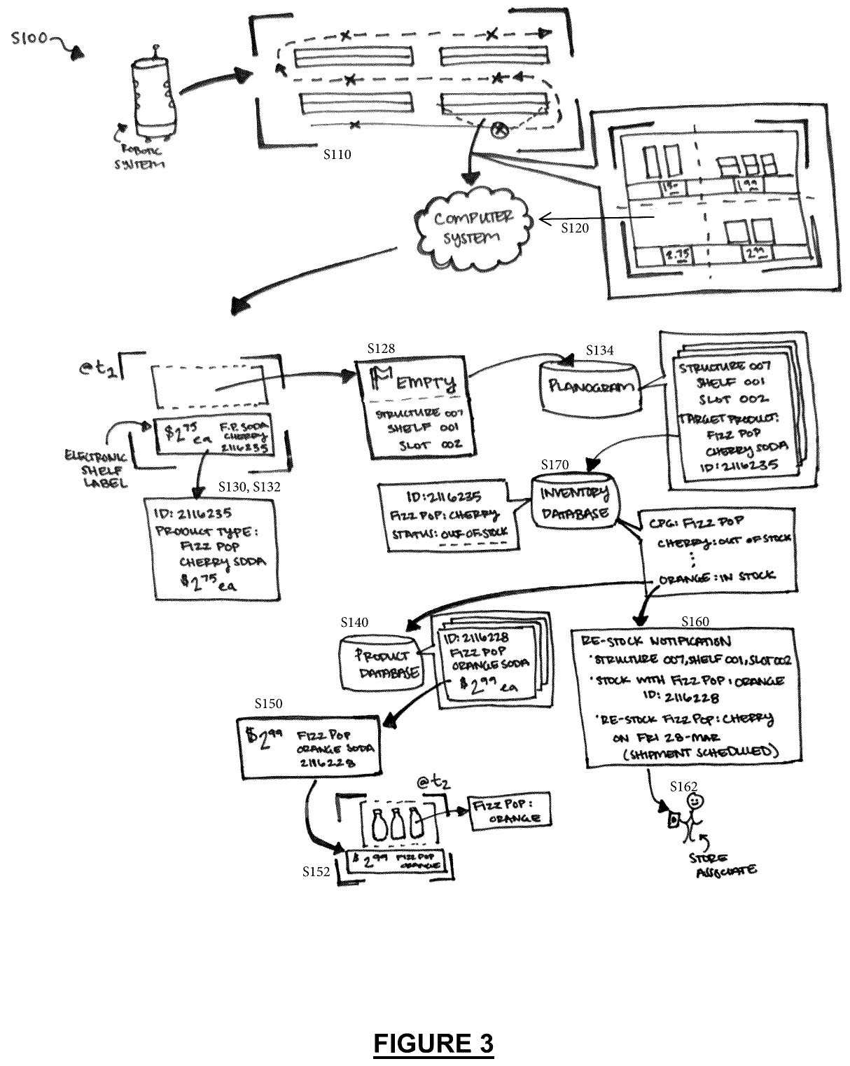

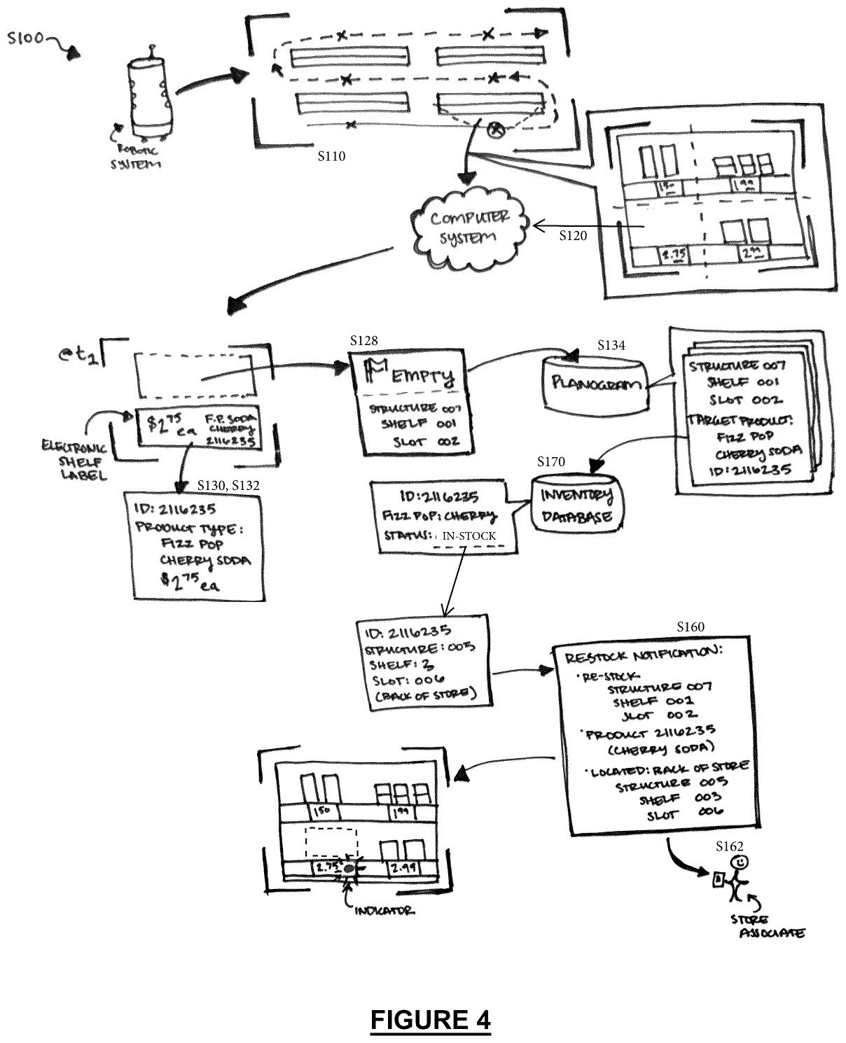

As shown in FIGS. 3, 4, 5A, 5B, and 7, one variation of the method S100 includes: accessing an image of an inventory structure captured by a robotic system while navigating through a store, the inventory structure defining a set of slots in Block Silo; detecting a first slot, in the set of slots, within the inventory structure in the image in Block S120; detecting a first object in a first lateral position in the image, the first lateral position below the first slot; extracting a second set of features from a second region of the image representing the first object; based on a first set of features extracted from a first region of the image, detecting absence of product units occupying the first slot in the image, the first region representing the first slot in Block S128; and, based on the second set of features, identifying a first electronic shelf label depicted in the second region of the image in Block S130. In this variation, the method S100 further includes, in response to detecting absence of product units occupying the first slot: accessing a target product type assigned to the first slot by a graphical representation of the store in Block S134; and accessing an inventory database defining stock conditions of a set of product types within the store in Block S170.

In this variation, the method S100 further includes, in response to the inventory database defining an out-of-stock condition for the target product type: generating a first notification to re-stock the first slot with product units of a first product type in replacement of the target product type in Block S160; transmitting the first notification to a computing device accessed by a store associate affiliated with the store in Block S162; accessing a first set of product data from a product database of the store, the first set of product data associated with the first product type; generating a second notification including the first set of product data in Block S150; and transmitting the second notification to the first electronic shelf label for rendering within an electronic display of the first electronic shelf label in Block S152.

In one variation, the method S100 includes, at a first time: accessing an image of an inventory structure captured by a robotic system while navigating through a store in Block Silo; detecting a first slot, in a set of slots in the inventory structure, depicted in the image in Block S120; identifying an electronic shelf label, arranged below the first slot in the set of slots, depicted in a first region of the image in Block S130; extracting a first set of product data from the first region of the image in Block S132; and detecting absence of product units occupying the first slot, in the set of slots, depicted in the image in Block S128.

This variation of the method S100 further includes, at the first time, in response to detecting absence of product units occupying the first slot, in the set of slots: accessing a target product type assigned to the first slot by a planogram of the store in Block S134; accessing a first location occupied by product units, of the target product type, from an inventory database of the store in Block S136; prompting a store associate to restock the particular slot with product units of the target product type from the first location in Block S140; generating a first electronic notification indicating the first location in Block S150; and transmitting the first electronic notification to the first electronic shelf label to render on an integrated display of the electronic shelf label for a first time window in Block S152.

This variation of the method S100 also includes, at a second time: accessing a second image of an inventory structure captured by a robotic system while navigating through a store in Block Silo; detecting the first slot, in the set of slots in the inventory structure, depicted in the second image in Block S120; extracting a first set of features from a first region of the second image in Block S124; based on the first set of features, identifying a product type of the first set of product units in Block S126; identifying the electronic shelf label, arranged below the first slot in the set of slots, depicted in the first region of the second image in Block S130; detecting presence of product units occupying the first slot, in the set of slots, depicted in the image in Block S134; and, in response to detecting presence of product units occupying the first slot in the set of slots, generating a second electronic notification indicating the first set of product data (e.g., revert back to the original product data) in Block S150 and transmitting the second electronic notification to the first electronic shelf label to render on the integrated display of the electronic shelf label in Block S152.

1.2 Variation: Reconcile Slot with Store Representation

As shown in FIGS. 1A, 1B, 5A, 5B, and 7, one variation of the method S100 includes: accessing an image of an inventory structure captured by a robotic system while navigating through a store at a first time, the inventory structure defining a set of slots in Block Silo; detecting a first slot, in the set of slots, depicted in the image in Block S120; identifying a first electronic shelf label depicted in a first region of the image arranged below the first region in Block S130; extracting a first set of product data from the first region of the image, the first set of product data corresponding to a first product type and rendered within an electronic display of the first electronic shelf label at the first time in Block S132; and accessing a target product type assigned to the first slot by a graphical representation of the store in Block S134. In this variation, the method S100 further includes, in response to the first product type, advertised by the first electronic shelf label, differing from the target product type assigned to the first slot: detecting a first set of product units occupying the first slot depicted in the image; extracting a first set of features from a first region of the image corresponding to the first slot; and, based on the first set of features, identifying a second product type of the first set of product units occupying the first slot in Block S126.

In this variation, the method S100 further includes, in response to the second product type corresponding to the target product type assigned to the first slot and in response to the second product type differing from the first product type advertised by the first electronic shelf label: accessing a second set of product data from a product database defined for the store, the second set of product data corresponding to the target product type of the first set of product units occupying the first slot in Block S140; generating a first notification including the second set of product data in Block S150; and transmitting the first notification to the first electronic shelf label for rendering within the electronic display of the first electronic shelf label in Block S152.

In one variation, the method S100 further includes, in response to the second product type differing from the target product type assigned to the first slot and in response to the second product type corresponding to the first product type advertised by the first electronic shelf label: generating a second notification including a prompt to reconcile the first slot and the graphical representation of the store; and transmitting the second notification to a computing device accessed by a store associate affiliated with the store.

### 1.3 Variation: Empty Slot+Alternative Product Type

One variation of the method S100 includes: accessing an image of an inventory structure captured by a robotic system while navigating through a store in Block Silo; detecting a first slot, in a set of slots in the inventory structure, depicted in the image in Block S120; identifying an electronic shelf label, arranged below the first slot in the set of slots, depicted in a first region of the image in Block S130; extracting a first set of product data from the first region of the image in Block S132; and detecting absence of product units occupying the first slot, in the set of slots, depicted in the image in Block S134.

This variation of the method S100 further includes, in response to detecting absence of product units occupying the first slot, in the set of slots: accessing a target product type assigned to the first slot by a planogram of the store in Block S134; and accessing an understock condition of product units, of the target product type, from an inventory database of the store in Block S136. This variation of the method S100 also includes: in response to detecting the understock condition, identifying an alternative product type for the first slot, in the set of slots in Block S138; prompting a store associate to restock the first slot, in the set of slots, with product units of the alternative product type in Block S140; generating an electronic notification indicating the alternative product type in Block S150; and transmitting the electronic notification to the electronic shelf label to render on an integrated display of the electronic shelf label in Block S152.

### 2. Applications

Generally, the method S100 can be executed by a computer system: to dispatch a robotic system to capture images of products arranged on shelves throughout a retail space (e.g., a grocery store) during a scan cycle; to access an image captured by the robotic system during this scan cycle; to detect presence or absence of product units occupying a particular slot—in an inventory structure within the store—depicted in the image; to identify an electronic shelf label, adjacent and corresponding to the particular slot, depicted in the image; to detect and read a set of product data (e.g., product type information, pricing information, nutritional information, a product identifier, a product SKU value) from an integrated display or an interface of the electronic shelf label; and to verify that these product data correspond to (e.g., match, align with, approximate) a target product type of the set of product units or a target set of product data assigned to the electronic shelf label by a planogram.

Then, responsive to detecting a discrepancy (e.g., discordance, a difference) between product data read from the electronic shelf label and a product type of product units occupying the corresponding slot, the computer system can automatically reconcile this discrepancy, such as: by updating the electronic shelf label to reflect an alternate product type currently occupying the slot; by updating the electronic shelf label to temporarily reflect an alternate product type currently occupying the slot; by updating the electronic shelf label to temporarily reflect other locations (e.g., an aisle number) of the product type—assigned to the slot—stocked elsewhere in the store; by selectively distributing prompts to store associates to correct or change stock in the slot; and/or by automatically pushing updates to the electronic shelf label to reflect slot corrections or stock changes made by store associates. Accordingly, the computer system can verify and maintain accuracy of product data rendered on this electronic shelf label and thus shorten periods of time in which erroneous or unhelpful information is rendered on this electronic shelf label.

More specifically, the computer system can: detect presence of product units, of a product type, occupying a particular slot—in an inventory structure within the store—depicted in the image; and access a target product type assigned to the particular slot. Responsive to detecting a discrepancy (e.g., discordance, a difference) between the product type detected in the image and the target product type assigned to the particular slot, the computer system can: access an understock condition (e.g., out-of-stock condition) of the target product type from an inventory database; update the electronic shelf label to temporarily reflect the product type currently occupying the slot; and revert the electronic shelf label to the target product type once the target product type is restocked in the store. Alternatively, the computer system can: access a location (e.g., an aisle, a top shelf, a storage room) of product units of the target product type elsewhere in the store from the inventory database; update the electronic shelf label to specify product units, of the product type, occupying this location; prompt a store associate to restock the slot with product units, of the product type, from this location; and revert the electronic shelf label to the target product type once the target product type is restocked in the slot.

Additionally, responsive to detecting absence of product units occupying a particular slot, in the inventory structure, depicted in the image a product unit occupying the slot, the computer system can: identify the particular slot as empty; access a target set of product data assigned to the electronic shelf label by the planogram; confirm a match (e.g., correspondence, alignment) between the target set of product data and the set of product data (extracted from a region of the image depicting the electronic shelf label); and scan the inventory database for product units of the target product type occupying other locations (e.g., an aisle number, a top shelf, a storage room) in the store. Then, in response to detecting product units of the target product type occupying another location in the store (e.g., an aisle number, a top shelf, a storage room), the computer system can a) prompt a store associate to restock the particular slot with product units of the target product type from this location or b) update the electronic shelf label to temporarily reflect this location occupied by product units of the target product type stocked elsewhere in the store.

Alternatively, in response to detecting absence of product units of the target product type occupying another location in the store (i.e., out-of-stock product units of target product type), the computer system can: identify an alternative product type associated with similar product units (e.g., similar consumer packaged goods); prompt a store associate to restock the particular slot with the alternative product type; and update the electronic shelf label to temporarily reflect this alternative product type.

The computer system can cooperate with the robotic system to similarly monitor and update many (e.g., hundreds, thousands of) electronic shelf labels located throughout the store based on images captured by the robotic system during a scan cycle.

Therefore, the computer system can execute Blocks of the method S100: to retrieve images of inventory structures within the store; to detect presence or absence of product units occupying a slot, in a set of slots, in the inventory structure; to detect a corresponding electronic shelf label for each slot; and to verify that product data read from each electronic shelf label corresponds to a current product type of these product units or a target set of product data assigned to the electronic shelf label. The computer system can then serve a notification or a prompt to each electronic shelf label in real-time in order to correct erroneous product data displayed on the electronic shelf label, thereby: enabling a customer to quickly identify a product as out-of-stock or identify a product as in stock and to find a store associate to restock the slot; enabling a store associate to restock a slot without manually checking a storage room for additional product units; and enabling the store to manage fluctuating inventory and display accurate product data on each electronic shelf label.

### 2.1 Applications: Check Inventory

Furthermore, in one implementation, in response to detecting absence of product units of a target product type—in a slot assigned to the target product type—the computer system can access inventory data for the store and identify whether: the target product type is in-stock at a different location within the store—such as in a different slot in an inventory structure in a customer region of the store and/or in a back-of-store inventory region of the store inaccessible to customers—and therefore available for re-stocking in the slot (e.g., by a store associate); the target product type is out-of-stock at the store and therefore unavailable for re-stocking in the slot; and/or the target product type is currently out-of-stock at the store but will be available at the store within a particular time period.

For example, the computer system can: execute Blocks of the method S100 to identify a set of product units of a first product type occupying a slot in an inventory structure depicted in an image captured by the robotic system; access a target product type assigned to the slot by a graphical representation of the store; and, in response to the target product type assigned to the slot differing from the first product type of the set of product units occupying the slot, identify a discrepancy—between the target product type and the first product type—at this particular slot. In response to identifying the discrepancy, the computer system can access an inventory database—defining stock conditions (e.g., in-stock, out-of-stock, low-stock) of a set of product types associated with the store—to identify whether product units of the target product type are available at an alternate location(s) within the store. Then, in response to identifying a first location associated with stock of product units of the target product type within the store, the computer system can: generate a first notification including a set of product data—corresponding to the first product type of product units occupying the slot—and specifying the first location associated with stock of product units of the target product type; generate a second notification including a prompt to re-stock the slot with product units of the target product type from the first location; transmit the first notification to an electronic shelf label corresponding to the slot, such that the electronic shelf label (temporarily) renders the set of product data—associated with the first product type (temporarily) occupying the slot—and the first location associated with stock of the target product type assigned to the slot; and transmit the second notification to a store associate for re-stocking the slot with product units of the target product type.

Alternatively, in response to the inventory database defining an out-of-stock condition for the target product type, the computer system can: temporarily update the electronic shelf label to render the set of product data associated with the first product type (e.g., as described above); access a product-ordering platform employed by the store to identify when stock of the target product type will be available for re-stocking in the slot; within the product-ordering platform, identify an order of product units of the target product type scheduled for delivery at a future time; generate a notification including a prompt to re-stock the slot with product units of the first product type for a time window expiring at the future time and including a second prompt to re-stock the slot with product units of the target product type at approximately the future time; and transmit the notification to the store associate (e.g., at a computing device accessed by the store associate).

### 3. Robotic System

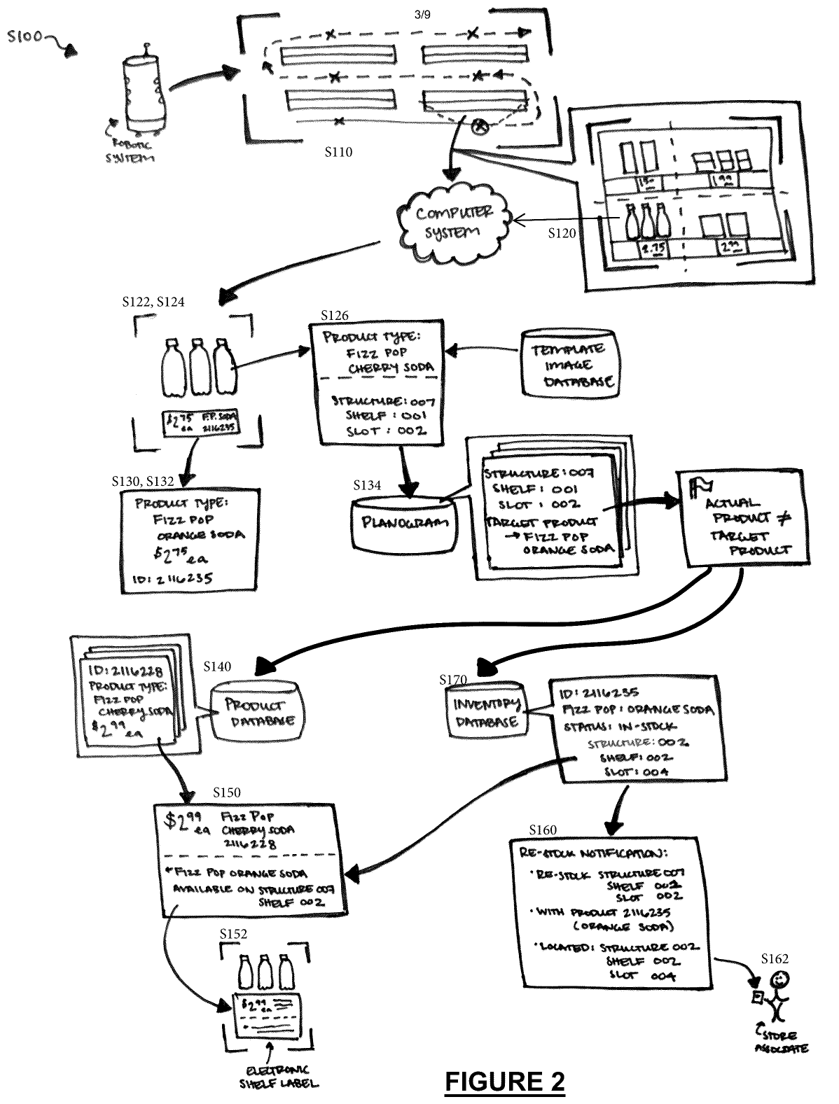

As shown in FIG. 2, a robotic system autonomously navigates throughout a store and records images—such as photographic images of packaged goods and/or depth images of inventory structures—continuously or at discrete predefined waypoints throughout the store during a scan cycle. Generally, the robotic system can define a network-enabled mobile robot configured to autonomously: traverse a store; capture photographic (e.g., color, black-and-white) and/or depth images of shelving structures, shelving segments, shelves, slots, or other inventory structures within the store; and upload those images to the computer system for analysis, as described below.

In one implementation shown in FIG. 2, the robotic system defines an autonomous imaging vehicle including: a base; a drive system (e.g., a pair of two driven wheels and two swiveling castors) arranged in the base; a power supply (e.g., an electric battery); a set of mapping sensors (e.g., fore and aft scanning LIDAR systems configured to generate depth images); a processor that transforms data collected by the mapping sensors into two- or three-dimensional maps of a space around the robotic system; a mast extending vertically from the base; a set of photographic cameras arranged on the mast; and a wireless communication module that downloads waypoints and a master map of a store from a computer system (e.g., a remote server) and that uploads photographic images captured by the photographic camera and maps generated by the processor to the computer system, as shown in FIG. 2. In this implementation, the robotic system can include photographic cameras mounted statically to the mast, such as a first vertical array of (e.g., two, six) photographic cameras on a left side of the mast and a second vertical array of photographic cameras on the right side of the mast, as shown in FIG. 2. The robotic system can additionally or alternatively include articulable photographic cameras, such as: one photographic camera on the left side of the mast and supported by a first vertical scanning actuator; and one photographic camera on the right side of the mast and supported by a second vertical scanning actuator. The robotic system can also include a zoom lens, a wide-angle lens, or any other type of lens on each photographic camera. However, the robotic system can define any other form and can include any other subsystems or elements supporting autonomous navigating and image capture throughout a store environment.

In one variation, the processor is configured to: extract unique identifiers (e.g., a product identifier, a shelf identifier, a QR code)—rendered on displays integrated into electronic shelf labels or applied to frames of electronic shelf labels—from the photographic images; detect conditions of the store in these photographic images; generate a prompt and/or notification according to a condition representing a particular change within the store; identify an electronic shelf label associated with each condition linked to the unique identifier; and queue the wireless communications module to wirelessly transmit (e.g., via broadcast or a wireless local ad hoc network) this prompt and/or notification to a corresponding electronic shelf label for display within the store.

Furthermore, multiple robotic systems can be deployed in a single store and can be configured to cooperate to image shelves and product units within the store. For example, two robotic systems can be deployed to a large single-floor retail store and can cooperate to collect images of all shelves and inventory structures in the store within a threshold period of time (e.g., within one hour). In another example, one robotic system is deployed on each floor of a multi-floor store, and each robotic system collects images of shelves and inventory structures on its corresponding floor. The computer system can then aggregate photographic and/or depth images captured by these robotic systems deployed in this store to generate a graph, map, table, and/or task list for managing distribution and restocking of product throughout the store.

### 4. Hierarchy and Terms

A “store” is referred to herein as a (static or mobile) facility containing one or more inventory structures.

A “product” is referred to herein as a type of loose or packaged good associated with a particular product identifier (e.g., a SKU) and representing a particular class, type, and varietal. A “unit” or “product unit” is referred to herein as an instance of a product—such as one bottle of detergent, one box of cereal, or package of bottled water—associated with one SKU value.

A “product facing” is referred to herein as a side of a product designated for a slot.

A “slot” is referred to herein as a section (or a “bin”) of a shelf on an “inventory structure” designated for storing and displaying product units of the product type (i.e., of the same SKU or CPU). An inventory structure can include a shelving segment, a shelving structure, or other product display containing one or more slots on one or more shelves.

A “planogram” is referred to herein as a plan or layout designating display and stocking of multiple product facings across multiple slots, such as: in a particular shelving segment; across a particular shelving structure; across multiple shelving structures within a particular aisle; across multiple aisles in the store; or throughout the entirety of the store. In particular, the planogram can specify a target product type, a target product placement, a target product quantity, a target product quality (e.g., ripeness, time to peak ripeness, maximum bruising), and/or a target product orientation for a fully-stocked slot for each slot represented in the planogram. For example, the planogram can define a graphical representation of an inventory structure in the store, including graphical representations of each slot in this inventory structure, each populated with a quantity of graphical representations of product type assigned to this slot equal to a quantity of product facings assigned to this slot. Alternatively, the planogram can record textual product placement for one or more inventory structures in the store in the form of a spreadsheet, slot index, or other database.

Furthermore, a “realogram” is referred to herein as a representation of the actual products, actual product placement, actual product quantity, and actual product orientation of products and product units throughout the store during a scan cycle, such as derived by the computer system according to Blocks of the method S100 based on photographic images and/or other data recorded by the robotic system while autonomously executing scan cycles in the store.

The method S100 is described herein as executed by a computer system (e.g., a remote server, a computer network) remote from the robotic system. However, Blocks of the method S100 can be executed locally by one or more robotic systems deployed in a retail space (or store, warehouse, etc.), by a local computer system (e.g., a local server), or by any other computer system.

Furthermore, Blocks of the method S100 are described below as executed by the computer system to identify products, to identify electronic shelf labels, and to verify product data displayed on these electronic shelf labels on open shelves in shelving structures within a grocery store. However, the computer system can implement similar methods and techniques to identify products, to identify electronic shelf labels, and to verify product data displayed on these electronic shelf labels on cubbies, in a refrigeration unit, on a wall rack, on a freestanding floor rack, on a table, on a hot-food display, or on or in any other product organizer, display, or other inventory structure in a retail space.

### 5. Robotic System Deployment and Scan Cycle

Generally, the computer system can dispatch the robotic system to autonomously navigate through a store and to record images of inventory structures within the store during a scan cycle. More specifically, the computer system can dispatch the robotic system to autonomously navigate along a preplanned sequence of waypoints or along a dynamic path and to record photographic images and/or depth images of inventory structures throughout the store.

### 5.1 Scan Cycle: Waypoints

In one implementation, the computer system: defines a set of waypoints specifying target locations within the store through which the robotic system navigates and captures images of inventory structures throughout the store during a scan cycle; and intermittently (e.g., twice per day) dispatches the robotic system to navigate through this sequence of waypoints and to record images of inventory structures nearby during a scan cycle. For example, the robotic system can be installed within a store, and the computer system can dispatch the robotic system to execute a scan cycle during store hours, including navigating to each waypoint throughout the store and collecting data representative of the stock state of the store in near real-time as patrons move, remove, and occasionally return product on, from, and to inventory structures within the store (e.g., shelving structures, refrigeration units, inventory structures, hanging racks, cubbies, etc.). During this scan cycle, the robotic system can: record photographic (e.g., color, black-and-white) images of each inventory structure; record depth images of all or select inventory structures; and upload these photographic and depth images to the computer system, such as in real-time or upon conclusion of the scan cycle. The computer system can then: detect types and quantities of packaged goods stocked in slots on these inventory structures in the store based on data extracted from these photographic and depth images; and aggregate these data into a realogram of the store.

The computer system can therefore maintain, update, and distribute a set of waypoints to the robotic system, wherein each waypoint defines a location within a store at which the robotic system is to capture one or more images from the integrated photographic and depth cameras. In one implementation, the computer system defines an origin of a two-dimensional Cartesian coordinate system for the store at a charging station—for the robotic system—placed in the store, and a waypoint for the store defines a location within the coordinate system, such as a lateral (“x”) distance and a longitudinal (“y”) distance from the origin. Thus, when executing a waypoint, the robotic system can navigate to (e.g., within three inches of) a (x,y) coordinate of the store as defined in the waypoint. For example, for a store that includes shelving structures with four-foot-wide shelving segments and six-foot-wide aisles, the computer system can define one waypoint laterally and longitudinally centered—in a corresponding aisle—between each opposite shelving segment pair. A waypoint can also define a target orientation, such as in the form of a target angle (“a”) relative to the origin of the store, based on an angular position of an aisle or shelving structure in the coordinate system. When executing a waypoint, the robotic system can orient to (e.g., within 1.5° of) the target orientation defined in the waypoint in order to align the suite of photographic and depth cameras to an adjacent shelving structure or inventory structure.

When navigating to a next waypoint, the robotic system can scan its environment with the same or other depth sensor (e.g., a LIDAR sensor, as described above), compile depth scans into a new map of the robotic system's environment, determine its location within the store by comparing the new map to a master map of the store defining the coordinate system of the store, and navigate to a position and orientation within the store at which the output of the depth sensor aligns—within a threshold distance and angle—with a region of the master map corresponding to the (x,y,∂) location and target orientation defined in this next waypoint.

In this implementation, before initiating a new scan cycle, the robotic system can download—from the computer system—a set of waypoints, a preferred order for the waypoints, and a master map of the store defining the coordinate system of the store. Once the robotic system leaves its dock at the beginning of a scan cycle, the robotic system can repeatedly sample its integrated depth sensors (e.g., a LIDAR sensor) and construct a new map of its environment based on data collected by the depth sensors. By comparing the new map to the master map, the robotic system can track its location within the store throughout the scan cycle. Furthermore, before navigating to a next scheduled waypoint, the robotic system can confirm completion of the current waypoint based on alignment between a region of the master map corresponding to the (x,y,∂) location and target orientation defined in the current waypoint and a current output of the depth sensors, as described above.

However, the robotic system can implement any other methods or techniques to navigate to a position and orientation in the store that falls within a threshold distance and angular offset from a location and target orientation defined by a waypoint.

### 5.2 Scan Cycle: Dynamic Path

In one implementation, during a scan cycle, the robotic system can autonomously generate a path through the store and execute this path in real-time based on: obstacles (e.g., patrons, spills, inventory structures) detected nearby; priority or weights previously assigned to inventory structures or particular slots within the store; and/or product sale data from a point-of-sale system connected to the store and known locations of products in the store, such as defined in a planogram. For example, the computer system can dynamically generate a path through the store during a scan cycle to maximize a value of inventory structures or a particular product recorded by the robotic system per unit time responsive to dynamic obstacles within the store (e.g., patrons, spills), such as described in U.S. patent application Ser. No. 15/347,689.

In this implementation, the robotic system can then continuously capture photographic images and/or depth images of inventory structures in the store (e.g., at a rate of 10 Hz, 24 Hz). However, the robotic system can capture images of inventory structures within the store at any other frequency during this scan cycle.

### 6. Image Access

Block S110 of the method S100 recites: accessing an image of an inventory structure captured by a robotic system while navigating through a store, the inventory structure defining a set of slots.

Generally, the robotic system can return images (e.g., photographic and/or depth images) recorded during the scan cycle to a remote database, such as in real-time during the scan cycle, upon completion of the scan cycle, or during scheduled upload periods within the scan cycle. The computer system can then access an image of an inventory structure, captured by the robotic system during the scan cycle, from this remote database in Block S110.

In one implementation, the computer system processes individual photographic images according to the method S100 in order to identify product units depicted in these individual images. Further, the computer system can: stitch multiple photographic images into one composite photographic image representing a length of one inventory structure or of multiple adjacent inventory structures; and then process this “composite” photographic image according to methods and techniques described below. Alternatively, the computer system can: stitch multiple depth images into one composite depth image representing the length of one inventory structure or of multiple adjacent inventory structures; and then process this “composite” depth image according to methods and techniques described below.

### 6.1 Image Segmentation+Shelf Detection+Electronic Shelf Label Detection

Block S120 of the method S100 recites: detecting a first slot, in the set of slots, within the inventory structure in the image. Furthermore, Block S130 of the method S100 recites: identifying a first electronic shelf label depicted in a second region of the image (e.g., below the first slot).

In one implementation, the computer system can implement methods and techniques described in U.S. patent application Ser. No. 17/169,326: to extract features from the photographic image and detect discrete shelf faces or shelves in the photographic image based on these features; to define a set of product regions, each product region depicting product units occupying one shelf in the inventory structure; and to update the realogram with representations of shelf faces and adjacent product regions for this inventory structure. Further, the computer system can: scan a shelf face region in the image for an electronic shelf label, extract product data from this electronic shelf label, and verify the product data with a product database or the planogram, as further described below.

In one variation, the computer system scans laterally across a first shelf face region—extracted from the image—for a barcode. Upon detecting a barcode in this first shelf face region, the computer system can: decode the barcode for a product identifier; query a product database for product data (e.g., a SKU value, a product description, and current product pricing) linked to this product identifier; read a slot address directly from the first shelf label containing this barcode or by querying the planogram for a slot address linked to this barcode; and read a price value from the first shelf face region.

In another variation, the computer system can detect the first slot in the inventory structure by locating the first slot in the inventory structure based on a position of the first electronic shelf label detected in the image. In this implementation, the computer system can: detect a first electronic shelf label on the inventory structure in the image; extract a set of features from the first electronic shelf label detected in the image, such as a barcode or a QR code; identify a first product identifier (e.g., a SKU value) of a first product type advertised by the first electronic shelf label based on the set of features; identify the first product type by querying a product database for this product identifier; and read a price value from the electronic shelf label.

### 6.1.1 Product Data Extraction

Generally, the computer system can detect and read product data (e.g., product type information, pricing information, quantity of a product type information) directly from an electronic shelf label arranged proximal each slot in the inventory structure.

In one implementation, the computer system can: access a photographic image—captured by the robotic system during a scan cycle—from a remote database; implement computer vision techniques (e.g., template matching, object recognition) to detect a slot in an inventory structure and an electronic shelf label on the inventory structure, proximal the slot, in the photographic image; identify a current product type, detected in the photographic image, in the slot; extract a set of features, representing a barcode or a QR code, from a region of photographic image depicting the electronic shelf label; and identify product data linked to the barcode or QR code by querying a product database.

Furthermore, product data can include: a product type; a price; a quantity of product units; a stock-keeping unit (SKU); a product description; nutritional values (e.g., “gluten free,” “vegan,” “wheat free,” “dairy free,” “organic,” “non-GMO,” “soy free,” “no added sugar,” and other relevant nutritional information); geometry features of the electronic shelf label (e.g., a rectangular or round shape); a visual indicator (e.g., an LED indicator); a color range; a customer review; customer ratings; and other relevant information on the shelf label.

In one variation, the computer system can access a product data schedule defined by an administrator or manager of the store and identify product data linked to the barcode or QR code within the schedule. Alternatively, the computer system can directly read current product data from the electronic shelf label and verify the accuracy of the current product data relative to the product data schedule. Further, the computer system can: access a photographic image captured by the robotic system; implement computer vision techniques (e.g., template matching, object recognition) to detect a slot in an inventory structure and an electronic shelf label on the inventory structure, proximal the slot, in the photographic image; identify a current product type, detected in the photographic image, in the slot; and implement optical character recognition techniques to read product data from a region of the photographic image depicting the electronic shelf label arranged on the inventory structure.

For example, the computer system can: read current product data, such as “Golden Delicious Apples,” “1.99 per lb.,” and “4 stars (30 reviews),” from a region of the photographic image depicting the electronic shelf label; extract a set of features representing a QR code from the region of the photographic image; query a product database for product data linked to the QR code, such as “Red Delicious Apples,” “1.79 per lb.,” and “4 stars (30 reviews);” and verify that the current product data corresponds to the product data linked to the QR code. Thus, the computer system can read current product data from an electronic shelf label and then verify the accuracy of the current product data relative to corresponding product data linked to an identifier (e.g., a barcode, a QR code) associated with the electronic shelf label, stored in the planogram, or defined in product data schedule for the store.

### 6.1.2 Electronic Shelf Label Status

In another variation, the computer system can implement methods and techniques described above to access a photographic image captured by the robotic system and identify an electronic shelf label on an inventory structure. The computer system can then: extract a set of features, representing an integrated display of the electronic shelf label, from a region of the photographic image; interpret a status of the electronic shelf label (e.g., “ON,” “OFF,” “DEAD BATTERY,” “BENT,” or “MISALIGNED”) based on the set of features; and store the status of the electronic shelf label in a status database (e.g., an inventory, a manifest) for the store.

In one example, the computer system can: extract a first set of features representing a particular identifier (e.g., barcode) displayed on the electronic shelf label from the photographic image; scan a product database for this barcode; identify a baseline geometry of the electronic shelf label associated with the barcode in the product database; extract a second set of features representing a geometry of the electronic shelf label from the photographic image; and, in response to misalignment between the geometry of the electronic shelf label and the baseline geometry, interpret a status of the electronic shelf label, such as “MISALIGNED” and store this status linked to the barcode for this electronic shelf label within a status database.

The computer system can repeat the methods and techniques described above for each other electronic shelf label and for each other inventory structure to generate a status of all electronic shelf labels arranged within the store.

### 7. Product Type+Product Data Verification

Generally, the computer system can: access an image captured by the robotic system; detect presence or absence of product units occupying a particular slot in an inventory structure within the store; identify an electronic shelf label adjacent the particular slot; retrieve product data from an integrated display or an interface of the electronic shelf label; verify these product data; and automatically generate and serve notifications to the electronic shelf label to render on an integrated display of the electronic shelf label in real-time.

More specifically, the computer system can: detect presence of product units occupying a particular slot in an inventory structure; identify an electronic shelf label adjacent the particular slot; retrieve product data from an integrated display interface of the electronic shelf label; and verify the accuracy of these product data relative to a current product type of the product units or a target set of product data assigned to the electronic shelf label. In response to discordance (e.g., a discrepancy, a difference) between the product data and the current product type or the target set of product data, the computer system can automatically generate a notification indicating the current product type or the target set of product data and serve this notification to the electronic shelf label.

Alternatively, the computer system can detect absence of product units occupying the particular slot in the inventory structure; identify an electronic shelf label adjacent the particular slot; retrieve product data from an integrated display of the electronic shelf label; access a target product type assigned to the particular slot and a quantity of product units, of the target product type, in stock within the store; and generate and serve a notification indicating the quantity of product units to the electronic shelf label.

### 7.1 Alternate Product in Slot: Actual Product Type Vs Target Product Type

Block S134 of the method S100 recites: accessing a target product type assigned to the first slot by a graphical representation of the store.

Generally, in one implementation, the computer system can access a target product type assigned to a particular slot by a graphical representation of the store—such as a planogram—and compare this target product type to an actual product type of product units occupying the particular slot. Then, in response to the target product type differing from the actual product type of product units occupying the particular slot, the computer system can trigger the electronic shelf label to update product data rendered within an electronic display of the electronic shelf label in order to render data associated with the actual product type and, therefore, ensure information (e.g., product type, pricing) relevant to the actual product type occupying the slot is shown within the electronic shelf label.

In particular, in this implementation, the computer system can: implement the methods and techniques described above to identify a first set of product units of a first product type occupying a first slot in an inventory structure depicted in an image captured by the robotic system; implement the methods and techniques described above to identify a first electronic shelf label depicted in a region of the image below (or proximal) the first slot; access a target product type assigned to the first slot by a graphical representation (e.g., a planogram) of the store; and extract a first set of product data—corresponding to the target product type and rendered within an electronic display of the first electronic shelf label—from the region of the image. Then, in response to the first product type—of the first set of product units occupying the first slot—differing from the target product type assigned to the first slot and advertised by the first electronic shelf label, the computer system can: access a second set of product data—corresponding to the first product type of the first set of product units occupying the first slot—from a product database defined for the store; generate a first notification including the second set of product data; and transmit the first notification to the first electronic shelf label for rendering within the electronic display of the first electronic shelf label.

The computer system can, therefore, temporarily update the electronic shelf label to reflect the actual product type occupying the slot until receipt of confirmation of re-stocking of the slot with product units of the target product type.

### 7.1.1 Alternate Product in Slot: Target Product In-Stock in Store

Generally, in response to the first product type—of the first set of product units occupying the first slot—differing from the target product type assigned to the first slot and advertised by the first electronic shelf label, the computer system can access an inventory database—defining stock conditions (e.g., in-stock, out-of-stock, low-stock) of a set of product types associated with the store—to identify whether product units of the target product type are available at an alternate location(s) within the store, such as in another slot within the inventory structure, in a different slot within a different inventory structure, and/or in a back-of-store location (e.g., inaccessible to customers of the store).

Furthermore, in this implementation, the computer system can: temporarily update the electronic shelf label to reflect the actual product type occupying the slot until receipt of confirmation of re-stocking of the slot with product units of the target product type (e.g., as described above); temporarily update the electronic shelf label to indicate a location of additional stock of the target product type in the store, if available; and prompt a store associate to re-stock the slot with product units of the target product type from this location in the store.

In particular, in response to the first product type differing from the target product type assigned to the first slot, the computer system can: access an inventory database defining stock conditions of a set of product types within the store; in response to the inventory database defining an in-stock condition for the target product type, access a first location of product units of the target product type associated with the in-stock condition; generate a first notification including a set of product data—corresponding to an actual product type of product units (temporarily) occupying the slot in replacement of the target product type—and indicating the first location associated with stock of the target product type; and transmit the first notification to the electronic shelf label for rendering within the electronic display of the electronic shelf label for a first time window.

Additionally, the computer system can prompt the store associate to re-stock the first slot with product units of the target product type from the first location. For example, the computer system can: generate a second notification including a prompt to stock the first slot with product units of the target product type from the first location prior to expiration of the first time window; and transmit the second notification to a store associate affiliated with the store.

In one example, the computer system can access the first location—associated with stock of the target product type in the store—from a realogram of the store generated from a first set of images captured by the robotic system during a scanning period. By extracting this first location from the realogram, the computer system can predict presence of product units of the target product type at the first location with relatively high confidence, based on detection of product units of the target product type in images—depicting an inventory structure at this first location—captured by the robotic system. Alternatively, in another example, the computer system can access the first location—associated with stock of the target product type in the store—from a planogram generated for the store.

### 7.1.2 Alternate Product in Slot: Target Product Out-of-Stock in Store

Additionally or alternatively, in one implementation, the computer system can: temporarily update the electronic shelf label to reflect the actual product type occupying the slot until receipt of confirmation of re-stocking of the slot with product units of the target product type (e.g., as described above); temporarily update the electronic shelf label to indicate an out-of-stock condition of the target product type; and prompt a store associate to re-stock the slot with product units of the target product type when new stock of the target product type is available in store.

In particular, in response to the first product type differing from the target product type assigned to the first slot, the computer system can: access an inventory database defining stock conditions of a set of product types within the store; in response to the inventory database defining an out-of-stock condition for the target product type, generate a first notification including a set of product data—corresponding to the first product type of product units occupying the first slot—and indicating the out-of-stock condition for the target product type; and transmit the first notification to the electronic shelf label for rendering within the electronic display of the electronic shelf label for a first time window.

Additionally, in this implementation, the computer system can access a product-ordering platform employed by the store to identify and/or predict when stock of the target product type will be available for re-stocking at the first slot. In particular, in response to the inventory database defining the out-of-stock condition for the target product type, the computer system can: access a product-ordering platform employed by the store; within the product-ordering platform, identify an order of product units of the target product type scheduled for delivery at a future time; generate a second notification including a first prompt to re-stock the first slot with product units of the first product type for a time window expiring at the future time and including a second prompt to re-stock the first slot with product units of the target product type at approximately the future time; and transmit the second notification to a computing device accessed by a store associate affiliated with the store. The computer system can thus ensure the first slot remains stocked with product until the scheduled shipment of additional stock of the target product arrives at the store.

7.2 Tag Differs from Store Representation (Product Type Advertised by Tag Differs from Target Product Type Assigned to Slot)

Additionally or alternatively, in one implementation, the computer system can access a target product type assigned to a particular slot by a graphical representation of the store (e.g., a planogram) and compare this target product type to a first product type advertised by the electronic shelf label corresponding to the particular slot.

Then, in response to the target product type differing from the first product type advertised by the electronic shelf label, the computer system can selectively: trigger an update to the electronic shelf label in response to an actual product type of product units occupying the first slot corresponding to the target product type and thus differing from the first product type advertised by the electronic shelf label; or serve a prompt to a store associate to reconcile the graphical representation of the store with the slot in response to the actual product type of product units occupying the first slot corresponding to the first product type advertised by the electronic shelf label and thus differing from the target product type.

In particular, in response to the first product type advertised by the electronic shelf label differing from the target product type assigned to the first slot, the computer system can verify whether a second product type (or “actual” product type) of product units occupying the first slot matches the target product type assigned to the first slot. In response to this second product type corresponding to (e.g., matching) the target product type, the computer system can: access a set of product data—corresponding to the target product type of product units occupying the first slot—from a product database defined for the store; generate a first notification including the set of product data; and transmit the first notification to the electronic shelf label for rendering within the electronic display of the electronic shelf label, such as in replacement of and/or in addition to product data associated with the first product type advertised by the electronic shelf label in the image.

Furthermore, in response to the second product type—of product units occupying the first slot—differing from the target product type assigned to the first slot and in response to the second product type corresponding to the first product type advertised by the first electronic shelf label, the computer system can: generate a notification including a prompt to reconcile the first slot and the graphical representation of the store; and transmit the notification to a computing device accessed by a store associate affiliated with the store. The computer system can, therefore, prompt the store associate to confirm whether the first electronic shelf label or the graphical representation of the store is accurate.

Furthermore, in response to the second product type—of product units occupying the first slot—differing from the target product type assigned to the first slot and in response to the second product type differing from the first product type advertised by the first electronic shelf label, the computer system can: access a second set of product data—corresponding to the first product type of the first set of product units occupying the first slot—from a product database defined for the store; generate a first notification including the set of product data; transmit the first notification to the first electronic shelf label for rendering within the electronic display of the first electronic shelf label; generate a second notification including a prompt to reconcile the first slot and the graphical representation of the store; and transmit the notification to a computing device accessed by a store associate affiliated with the store.

Therefore, the computer system can: trigger an update to the first electronic shelf label to ensure that product data rendered by the first electronic shelf label corresponds to product occupying the first slot; and prompt the store associate to confirm whether the first electronic shelf label or the graphical representation of the store is accurate.

### 7.2 Verification of Label+Product Present+Target Product

Additionally or alternatively, in one variation, the computer system can selectively confirm verification of a particular slot loaded with product units of a first product type corresponding to (e.g., matching) a second product type advertised by the electronic shelf label—associated with the particular slot—and corresponding to a target product type assigned to the particular slot by a graphical representation (e.g., a planogram) of the store.

In particular, in this variation, the computer system can: implement the methods and techniques described above to identify a first set of product units of a first product type occupying a first slot of an inventory structure depicted in an image captured by the robotic system; implement the methods and techniques described above to identify a first electronic shelf label depicted in a region of the image; access a target product type assigned to the first slot by a graphical representation of the store; extract a first set of product data—corresponding to a second product type advertised by the first electronic shelf label—from the region of the image; and, in response to the first product type corresponding to the target product type—assigned to the first slot—and in response to the first product type corresponding to the second product type advertised by the first electronic shelf label, confirm verification of the first slot. Alternatively, in response to the first product type differing from the target product type and/or differing from the second product type, the computer system can withhold verification of the first slot.

### 7.4 Product Present+Product Type Discordance

In one implementation, the computer system can execute Blocks of the method S100: to identify a current product type of a set of product units detected in the photographic image; to extract a set of features representing product data displayed on the electronic shelf label from a region of the photographic image; and to verify correspondence between these product data, displayed on the electronic shelf label, and the current product type. Responsive to discordance between the set of product data and the current product type, the computer system can push a notification with the updated product data to the electronic shelf label in real-time.

For example, the computer system can: access an image of an inventory structure captured by the robotic system; detect a slot in the inventory structure, depicted in the image; detect a set of product units, such as cans occupying the slot, depicted in the image; extract a first set of features from a first region of the image; based on the first set of features, identify a first product type, such as original potato crisps, of the set of product units; and identify an electronic shelf label, arranged below the slot, depicted in the image. The computer system can then: retrieve pricing information and an average customer rating, such as “2.99 EA” and “four stars”, from the electronic shelf label; and extract a second product type, such as “pretzels”, from the electronic shelf label. Responsive to discordance (e.g., a difference, a discrepancy) between the first product type and the second product type, the computer system can: generate a notification indicating the first product type, such as original potato crisps; and wirelessly transmit the notification to the electronic shelf label to render on an integrated display of the electronic shelf label.

Therefore, the computer system can identify a discrepancy between a current product type detected in the photographic image and a product type retrieved from an electronic shelf label and serve a notification with an accurate product type to the electronic shelf label for display in real-time.

### 7.5 Product Present+Target Product Data Discordance

In one implementation, the computer system can detect a set of product units occupying a particular slot in the inventory structure, depicted in the image. Then, in response to detecting absence of a product type (e.g., fail to detect a product type) in the image, the computer system can: identify an electronic shelf label adjacent the particular slot; extract product data from the electronic shelf label; and access a target set of product data assigned to the electronic shelf label by the planogram or an electronic shelf label schedule. Responsive to discordance between the set of product data and the target set of product data, the computer system can push a notification with the target product data to the electronic shelf label to render on an integrated display of the electronic shelf label in real-time.

For example, the computer system can: access an image of an inventory structure captured by the robotic system; detect a slot in the inventory structure, depicted in the image; detect a set of product units occupying the slot, depicted in the image; extract a set of features representing a product facing of a product unit, in the set of product units, from a region of the image; detect absence of a product type, such as a blurred or out-of-focus product facing, based on the set of features; identify an electronic shelf label, adjacent the slot, depicted in a second region of the image; extract a set of product data from the second region of the image; and access a target set of product data assigned to the electronic shelf label by the planogram. Then, in response to discordance between the first set of product data and the target set of product data, the computer system can: generate an electronic notification to replace the first set of product data with the target set of product data; and wirelessly transmit the electronic notification to the electronic shelf label to render on an integrated display.

### 7.6 Product Absent+Product Units in Stock

In one implementation, the computer system can implement methods and techniques described above to detect absence of product units occupying a particular slot, in the inventory structure, depicted in the image. Then, in response to detecting absence of product units, the computer system can: access a target product type assigned to the particular slot by a planogram of the store; access a quantity of product units, of the target product type, in stock or out-of-stock from an inventory database of the store; and generate and serve a notification indicating the quantity of product units to the electronic shelf label.

In one variation, the computer system can: detect absence of product units occupying a particular slot, in the inventory structure, depicted in the image; access a target product type assigned to the particular slot by the planogram; and access presence (e.g., a quantity or a location) of product units, of the target product type, in stock within the store from the inventory database. The computer system can automatically serve a notification indicating the quantity or location of product units in stock to the electronic shelf label and prompt a store associate to restock the product units in this particular slot.

For example, the computer system can: detect absence of product units, such as sodas, occupying a slot in the inventory structure, depicted in the image; access the planogram representing product types and placement of each product type within a grocery store; retrieve a target product type, such as zero-sugar, cherry flavored soda, assigned to the slot; access the inventory database representing quantities of stocked product units available in a storage room of the store; retrieve a quantity of the product units, such as ten zero-sugar, cherry flavored sodas, in stock within a storage room of the store from the inventory database; generate a notification indicating ten zero-sugar, cherry flavored sodas available in the storage room of the store; generate a prompt for customers to ask a store associate to retrieve zero-sugar, cherry flavored sodas from the storage room; and wirelessly transmit the notification and the prompt to the electronic shelf label, adjacent the particular slot, to render on an integrated display of the electronic shelf label.

In another variation, the computer system can retrieve a target product type assigned to the slot from the planogram; access a target quantity of product units, of the target product type, in stock from the inventory database of the store; and, in response to detecting a difference between the quantity of product units available in the store and the target quantity of product units assigned to the particular slot, automatically generate an electronic notification updating the product data to indicate the quantity of product units available in the store and transmit this electronic notification to the electronic shelf label. For example, the computer system can: retrieve a target quantity of product units, such as 24 product units, assigned to the particular slot from the planogram; and retrieve a quantity of product units, such as 12 product units, in stock (e.g., available) in the store from the inventory database. Then, in response to the quantity of products units, such as 12 product units, falling below the target quantity of product units such as 24 products, the computer system can: generate an electronic notification updating the product data to indicate the 12 product units available in the store and a prompt such as “Ask a store associate to retrieve the 12 product units in stock from the storage room”; and wirelessly transmit this electronic notification to the electronic shelf label for display in real-time. A customer may then read the integrated display of the electronic shelf label and find a store associate to restock this slot.

Therefore, the computer system can: automatically adjust product data according to a quantity of product units in stock; and wirelessly transmit this product data to the corresponding electronic shelf label in real-time. Additionally, the computer system and the electronic shelf label can cooperate to enable a user to quickly identify a product as in stock and to find a store associate to restock the slot without the store associate manually checking a storage room for additional product units of a particular type.

### 7.6.1 Product Absent+Product Units Out-of-Stock

In one variation, the computer system can: detect absence of product units occupying a particular slot, in the inventory structure, depicted in the image; access a target product type assigned to the particular slot by the planogram; and access a null quantity of product units, of the target product type, from the inventory database (e.g., out-of-stock product units of product type). The computer system can automatically generate and serve a notification indicating product units of the target product type as out-of-stock to the electronic shelf label.

Additionally or alternatively, the computer system can: generate a notification including product data of an alternate product type in replacement of the target product type in response to identifying an out-of-stock condition for the target product type; and transmit the notification to the electronic shelf label for rendering product data of the alternate product type.

In particular, the computer system can: based on a first set of features extracted from a first region of the image, detect absence of product units occupying a first slot in an image, the first region representing the first slot; and, based on a second set of features extracted from a second region of the image, identify a first electronic shelf label depicted in the second region of the image. Then, in response to detecting absence of product units occupying the first slot, the computer system can: access a target product type assigned to the first slot by a graphical representation of the store; and access an inventory database defining stock conditions of a set of product types within the store. Then, in response to the inventory database defining an out-of-stock condition for the target product type, the computer system can: generate a first notification to re-stock the first slot with product units of a first product type in replacement of the target product type; transmit the first notification to a computing device accessed by a store associate affiliated with the store; access a first set of product data from a product database of the store, the first set of product data associated with the first product type; generate a second notification including the first set of product data; and transmit the second notification to the first electronic shelf label for rendering within an electronic display of the first electronic shelf label.

Additionally or alternatively, the computer system can: access a null quantity of product units, of the target product type, from the inventory database (e.g., out-of-stock product units of product type); scan the planogram representing placement and product types in the store; identify a first aisle number, associated with the inventory structure, in the planogram; retrieve a second aisle number, different from the first aisle number, for product units of the current product type in the planogram; generate a notification indicating the aisle number for other product units of the product type; and wirelessly transmit the notification to the electronic shelf label for display.

Therefore, the computer system and electronic shelf label cooperate to enable a user to quickly identify a product as out-of-stock without interacting with a store associate. Additionally, the computer system can generate and serve a notification for an aisle number associated with product units, of the product type, to the electronic shelf label in order to guide a customer to product units located elsewhere in the store.

### 7.6.2 Product Quantity Deviation+Update Store Associate

In one variation, the computer system can detect a product quantity on an inventory structure and alert a store associate to restock a particular product type responsive to the product quantity falling below a threshold target quantity. Further, the computer system can generate a prompt for a store associate to restock the product units in this particular slot and transmit the prompt to a computing device associated with the store associate.

In one implementation, the computer system can detect a difference between the quantity of product units available in the store and the target quantity of product units assigned to the particular slot and, in response to the difference exceeding a threshold difference, generate a prompt for a store associate to restock this particular slot with the target quantity of product units. For example, the computer system can: extract a first set of features from an electronic shelf label detected in an image of an inventory structure; identify a first slot in the inventory structure corresponding to the electronic shelf label; identify a product type specified by the electronic shelf label based on the first set of features; interpret a target quantity of product units of the product type assigned to the first slot based on the first set of features; extract a second set of features from a region of the image depicting the first slot; identify a quantity of product units of the product type occupying the first slot based on the second set of features; and, in response to the quantity of product units differing from the target quantity by more than a threshold difference, generate a prompt to restock the first slot with product units of the product type and wirelessly transmit the prompt to a computing device associated with a store associate.

Therefore, the computer system can: automatically adjust product data, displayed on an electronic shelf label, according to a quantity of product units in stock and directly prompt a store associate to restock the slot in real-time. Thus, the computer system can enable a store associate to quickly restock the slot without manually checking a storage room for additional in stock product units.

### 8. Notifications+Updates to the Electronic Shelf Label

Blocks S150 and S152 of the method S100 recite: generating a first notification including the second set of product data; and transmitting the first notification to the first electronic shelf label for rendering within the electronic display of the first electronic shelf label.

Generally, in response to a first product type of product units—currently occupying the slot—differing from a second product type advertised by the electronic shelf label, the computer system can: access a second set of product data—corresponding to the first product type—from a product database defined for the store; generate a notification including the second set of product data; and transmit the notification to the electronic shelf label for rendering within the electronic display in replacement of a first set of product data corresponding to the second product type.

In one implementation, the computer system can trigger the electronic shelf label to concurrently render both the first set of product data—corresponding to the target product type assigned to the slot—and the second set of product data corresponding to the first product type of the set of product units occupying the slot.

In particular, in this implementation, the computer system can: identify a set of product units of a first product type occupying the slot depicted in the image captured by the robotic system (e.g., as described above); identify an electronic shelf label depicted in a region of the image; and extract a first set of product data—corresponding to a target product type assigned to the slot and advertised by the electronic shelf label—from the region of the image. Then, in response to the first product type—of the set of product units occupying the slot—differing from the target product type assigned to the slot and advertised by the electronic shelf label, the computer system can: access a second set of product data—corresponding to the first product type of the first set of product units occupying the first slot—from a product database defined for the store; and generate a notification including the second set of product data. The computer system can then transmit the notification to the electronic shelf label for rendering within the electronic display of the electronic shelf label, the electronic display configured to, responsive to receipt of the notification: render the first set of product data within a first region of the electronic shelf label, the first set of product data corresponding to the target product type assigned to the slot by the graphical representation of the store; and render the second set of product data within a second region of the electronic shelf label, the second set of product data corresponding to the first product type of the set of product units occupying the slot.

For example, the computer system can generate the notification including: a first command to render the first set of product data within a first subregion (e.g., an upper region) of the electronic display of the electronic shelf label; and a second command to render the second set of product data within a second subregion (e.g., a lower region) of the electronic display.

Therefore, the computer system can trigger the electronic shelf label to render information regarding both the target product type assigned to the slot and the (current) first product type occupying the slot, thereby enabling store associates and customers to access: information relevant to the set of product units currently occupying the slot; and information regarding the target product type assigned to this slot.

Additionally or alternatively, in another implementation, the computer system can trigger the electronic shelf label to alternate rendering of the first set of product data—corresponding to the target product type assigned to the slot—and the second set of product data corresponding to the first product type of the set of product units occupying the slot, such as according to a fixed schedule.

In particular, in this implementation, the computer system can: identify a set of product units of a first product type occupying the slot depicted in the image captured by the robotic system; identify an electronic shelf label depicted in a region of the image; extract a first set of product data—corresponding to a target product type assigned to the slot and advertised by the electronic shelf label—from the region of the image; and, in response to the first product type differing from the target product type assigned to the first slot and advertised by the electronic shelf label, access a second set of product data—corresponding to the first product type of the first set of product units occupying the slot—from a product database defined for the store, and generate a notification including the second set of product data. The computer system can then transmit the notification to the electronic shelf label for rendering within the electronic display of the electronic shelf label, the electronic display configured to, responsive to receipt of the notification: render the first set of product data within the electronic shelf label during a first time window; and render the second set of product data within the electronic shelf label during a second time window offset the first time window, the second set of product data corresponding to the first product type of the first set of product units occupying the first slot. Therefore, the computer system can trigger the electronic shelf label to oscillate between rendering the first set of product data and the second set of product data.

For example, the computer system can generate the notification including: a first command to render the first set of product data within the electronic display of the electronic shelf label during a first display cycle repeating at a first frequency; and a second command to render the second set of product data within the electronic display during a second display cycle—offset and interposed between instances of the first display cycle—repeating at approximately the first frequency. In particular, in this example, the computer system can trigger the electronic shelf label to: render the first set of product data during a first instance of the first display cycle spanning a duration of 10 seconds; render the second set of product data during a first instance of the second display cycle spanning the duration of 10 seconds responsive to expiration of the first instance of the first display cycle; render the first set of product data during a second instance of the first display cycle spanning the duration of 10 seconds responsive to expiration of the first instance of the second display cycle; render the second set of product data during a second instance of the second display cycle spanning the duration of 10 seconds responsive to expiration of the second instance of the first display cycle; and repeat this process for a defined time period.

### 8.1.1 Product Location+Electronic Shelf Label Indicator Light

In one implementation, the computer system can: receive a request for a product of interest to a user from a computing device accessed by the user; identify an aisle number and a color value of an electronic shelf label associated with the particular product within the store as defined in the planogram; transmit the aisle number and the color value to the computing device; and automatically update the visual indicator of the electronic shelf label within the store with the color value.

Furthermore, the computer system can pseudo-randomly assign a color value within a color range—such as a color value (e.g., a RGB color value or a hex color code) within a color range (e.g., blue, green, red, yellow)—to a request according to the order in which the request is received. Alternatively, the computer system can access a color value database; scan the color value database for a predefined color value assigned to a particular product defined in the request; retrieve this color value from the color value database; and assign this color value to the request. For example, an administrator or store manager may: define a list of product types located within the store such that each product type is assigned to a particular color range (e.g., blue, green, red, yellow); and upload this list within the administrator portal. The computer system can then: interface with the user portal to retrieve this list of product types assigned to color ranges; pseudo-randomly assign an RGB color value to each color range; and store this list in a color value database.

In one variation, the computer system can: receive a request for a particular product unit within the store from a computing device accessed by a user (e.g., customer); implement methods and techniques described above to identify the particular product unit occupying a slot in the inventory structure; access a three-dimensional coordinate system representing geospatial locations of products within the store; identify a geospatial location associated with the particular product unit within the three-dimensional coordinate system; retrieve an aisle number associated with the geospatial location; identify a corresponding electronic shelf label and unique identifier linked to the electronic shelf label; assign a color value to the request; transmit the aisle number and the color value to the computing device; and update the electronic shelf label to display the color value for a time window.

Therefore, the computer system can: provide an aisle number of a particular product of interest to a user; and automatically update an electronic shelf label, associated with the particular product, with a color value, thereby enabling the user to visually identify the particular product of interest and reduce the user's time spent searching within the store.

Additionally or alternatively, in another implementation, the computer system can selectively trigger the electronic shelf label to render a visual indicator (e.g., a color indicator) to: indicate an action required by a store associate at this particular slot, such as re-stocking of product units of a particular product type within this particular slot; and visually attract the store associate's attention and therefore enable the store associate to rapidly locate a particular slot corresponding to the electronic shelf label.

In one example, the computer system can implement the methods and techniques described above to identify a difference (or “discrepancy”) between a first product type—of product units occupying a slot—and a target product type assigned to the slot (e.g., by a store planogram) and advertised by the electronic shelf label; and, in response to identifying the difference, access a set of product data—corresponding to the first product type of the first set of product units occupying the first slot—from a product database defined for the store. The computer system can then generate a notification including: the second set of product data; a first command to render the set of product data within a first subregion of the electronic display of the electronic shelf label; and a second command to render a first visual indicator (e.g., a particular color indicator)—configured to indicate replacement of product units of the target product type with product units of the first product in this slot—within a second subregion of the electronic display. Therefore, in this example, the computer system can trigger rendering of the first visual indicator within the electronic shelf label in order to alert a store associate that an alternate product type—different from the target product type assigned to this slot—is temporarily stocked in this slot.

### 9. Closing the Loop: Verifying Real-Time Update to Electronic Shelf Label

In one implementation, the computer system can verify updating of product data rendered by the electronic shelf label in (near) real-time.

In particular, in this implementation, the computer system can: identify a difference (or “discrepancy”) between a first product type of product units occupying a slot and a second product type advertised by the electronic shelf label; at a first time, trigger an update to the electronic shelf label to rectify the difference, such as by transmitting a notification—to render a first set of product data corresponding to the first product type in replacement of a second set of product data corresponding to the second product type—to the electronic shelf label (e.g., as described above); at a second time succeeding the first time (e.g., within seconds), trigger the robotic system to capture a second image of the inventory structure including the slot; receive the second image captured by the robotic system; and implement the methods and techniques described above to detect the slot and electronic shelf label in the second image. Then, the computer system can: extract a third set of product data—rendered within the electronic display of the electronic shelf label—from a region of the second image occupied by the electronic shelf label; and, in response to the third set of product data corresponding to (e.g., matching) the first set of product data corresponding to the first product type of product units occupying the slot, verify successful updating of the electronic shelf label (e.g., according to the notification served to the electronic shelf label).

Alternatively, in response to the third set of product differing from the first set of product data and corresponding to (e.g., matching) the second set of product data originally rendered within the electronic shelf label at the first time, the computer system can: flag this electronic shelf tag for further investigation; interpret an error event associated with the electronic shelf label; generate a prompt to investigate the electronic shelf label; and transmit the prompt to a computing device accessed by a store associate affiliated with the store.

For example, in response to flagging the electronic shelf label based on detection of absence of an update to the electronic shelf label, the computer system can interpret an error event for the electronic shelf label, such as corresponding to: an incorrect identifier associated with the electronic shelf tag and, therefore, updating of a different electronic shelf label rather than this (target) electronic shelf label; a “dead” electronic shelf label requiring additional power supply; loss of connectivity of the electronic shelf label to a local network; etc. The computer system can thus prompt the store associate to investigate the electronic shelf label to confirm a type of error event for this electronic shelf label and rectify the error event accordingly.

### 9.1 Closing the Loop: Verifying Re-Stocking of Target Product in Slot+Reverting the Electronic Shelf Label

In one variation, the computer system can verify re-stocking of a slot with the target product type—in replacement of an alternate product type temporarily occupying the slot—and update the electronic shelf label accordingly.

In particular, in this variation, during a first time period, the computer system can: identify a difference (or “discrepancy”) between a first product type of product units occupying a slot and a second product type advertised by the electronic shelf label; and, at a first time, trigger an update to the electronic shelf label to rectify the difference, such as by transmitting a notification—to render a first set of product data corresponding to the first product type in replacement of a second set of product data corresponding to the second product type—to the electronic shelf label (e.g., as described above). Then, during a second time period succeeding the first time period, the computer system can: receive a second image captured by the robotic system at a second time succeeding the first time; implement the methods and techniques described above to detect the slot and the electronic shelf label in the second image; detect a set of objects occupying the slot in the second image; extract a set of features from a region of the second image representing the set of objects; and, based on the set of features, identify a set of product units of a third product type occupying the slot at the second time. Then, in response to the third product type corresponding to the second product type—advertised by the electronic shelf label during the first time period and/or corresponding to a target product type defined by a graphical representation (e.g., a planogram) of the store—the computer system can: generate a second notification including the second set of product data corresponding to the second product type (and the target product type); and transmit the second notification to the electronic shelf label for rendering the second set of product data at the electronic shelf label.

Therefore, the computer system can ensure the electronic shelf label is updated—such as by reverting to the second set of product data rendered within the electronic display—to advertise the target product type once the target product type is re-stocked in the slot.

### 10. Product Contract Compliance+Rules

Generally, the computer system can evaluate a product placement of a store representing the store's compliance with product contracts—each product contract specifying a particular product type for display on an end cap of an inventory structure in the store and a set of rules associated with the product type. The computer system can then provide product placement metrics and insights to a store team and/or a corporate team via an administrator portal.

More specifically, the computer system can: identify compliant areas of the store with a corresponding product contract; identify non-compliant areas of the store with a corresponding product contract; generate a ratio of non-compliant areas to compliant areas of the store; transform this ratio into a product compliance score for the store; and present the product compliance score to a store team and/or a corporate team via an administrator portal. Thus, the computer system can enable the store team and/or the corporate team to quickly address non-compliant areas within the store in real-time rather than manually and randomly evaluating product unit placement with a corresponding product contract.

In one implementation, the computer system can identify a product type of a set of product units, occupying a slot of a particular end cap and verify the compliance of the product type with a set of rules defined in a corresponding product contract for this particular end cap. For example, the computer system can: detect absence of a product unit in a particular slot on an end cap of the inventory structure; access the planogram representing product types and inventory quantities of each product type within the store; retrieve a target product type assigned to the slot and a product quantity of the target product type available in the store from the planogram; and, in response to detecting a null quantity available of the target product type (i.e., the product type is out of stock), access the set of rules associated with the product type from a corresponding product contract and select a next highest ranking product type from the product contract.

Accordingly, the computer system can: access the planogram representing product types and inventory quantities of each product type within the store; retrieve a product quantity of the next highest ranking product type in stock in the store from the planogram; generate a prompt for a store associate to restock the slot with the next highest ranking product type according to the product quantity; and wirelessly transmit the prompt to a computing device associated with a store associate.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing an image of an inventory structure captured by a robotic system while navigating through a store, the inventory structure defining a set of slots;
detecting a first slot, in the set of slots, within the inventory structure in the image;
detecting a first set of objects occupying the first slot in the image;
extracting a first set of features from a first region of the image representing the first set of objects;
based on the first set of features, identifying a first set of product units of a first product type occupying the first slot;
accessing a target product type assigned to the first slot by a graphical representation of the store;
detecting a first object in a first lateral position in the image, the first lateral position below the first slot;
extracting a second set of features from a second region of the image representing the first object;
based on the second set of features, identifying a first electronic shelf label depicted in the second region of the image;
extracting a first set of product data from the second region of the image, the first set of product data corresponding to the target product type and rendered within an electronic display of the first electronic shelf label; and
in response to the first product type differing from the target product type assigned to the first slot and advertised by the first electronic shelf label:
accessing a second set of product data from a product database defined for the store, the second set of product data corresponding to the first product type of the first set of product units occupying the first slot;
generating a first notification comprising the second set of product data; and
transmitting the first notification to the first electronic shelf label for rendering within the electronic display of the first electronic shelf label.

2. The method of claim 1:
further comprising, in response to the first product type differing from the target product type assigned to the first slot, accessing an inventory database defining stock conditions of a set of product types within the store; and
wherein generating the first notification comprising the second set of product data comprises, in response to the inventory database defining an out-of-stock condition for the target product type, generating the first notification comprising the second set of product data and indicating the out-of-stock condition for the target product type.

3. The method of claim 2, further comprising, in response to the inventory database defining the out-of-stock condition for the target product type:
accessing a product-ordering platform employed by the store;
within the product-ordering platform, identifying an order of product units of the target product type scheduled for delivery at a future time;
generating a second notification comprising a prompt to re-stock the first slot with product units of the first product type for a time window expiring at the future time; and
transmitting the second notification to a computing device accessed by a store associate affiliated with the store.

4. The method of claim 1:
further comprising, in response to the first product type differing from the target product type assigned to the first slot:
accessing an inventory database defining stock conditions of a set of product types within the store; and
in response to the inventory database defining an in-stock condition for the target product type, accessing a first location of product units of the target product type associated with the in-stock condition;
wherein generating the first notification comprising the second set of product data comprises, in response to the inventory database defining the in-stock condition for the target product type, generating the first notification comprising the second set of product data and indicating the first location associated with stock of the target product type; and
wherein transmitting the first notification to the first electronic shelf label for rendering within the electronic display of the first electronic shelf label comprises transmitting the first notification to the first electronic shelf label for rendering within the electronic display of the first electronic shelf label for a first time window.

5. The method of claim 4, further comprising, in response to the inventory database defining the in-stock condition for the target product type:
generating a second notification comprising a prompt to stock the first slot with product units of the target product type from the first location prior to expiration of the first time window; and
transmitting the second notification to a store associate affiliated with the store.

6. The method of claim 1, wherein transmitting the first notification to the first electronic shelf label for rendering within the electronic display of the first electronic shelf label comprises transmitting the first notification to the first electronic shelf label for rendering within the electronic display of the first electronic shelf label, the electronic display configured to, responsive to receipt of the first notification:
render the first set of product data within a third region of the electronic shelf label, the first set of product data corresponding to the target product type assigned to the first slot by the graphical representation of the store; and
render the second set of product data within a fourth region of the electronic shelf label, the second set of product data corresponding to the first product type of the first set of product units occupying the first slot.

7. The method of claim 1, wherein transmitting the first notification to the first electronic shelf label for rendering within the electronic display of the first electronic shelf label comprises transmitting the first notification to the first electronic shelf label for rendering within the electronic display of the first electronic shelf label, the electronic display configured to, responsive to receipt of the first notification:
render the first set of product data within the electronic shelf label during a first time window; and
render the second set of product data within the electronic shelf label during a second time window offset the first time window, the second set of product data corresponding to the first product type of the first set of product units occupying the first slot.

8. The method of claim 1:
wherein transmitting the first notification to the first electronic shelf label comprises transmitting the first notification to the first electronic shelf label at a first time; and
further comprising:
accessing a second image of the inventory structure captured by the robotic system at a second time succeeding the first time;
detecting the first slot within the inventory structure in the second image;
detecting a second object in a second lateral position in the second image, the second lateral position below the first slot;
extracting a third set of features from a third region of the second image representing the second object;
based on the third set of features, identifying the first electronic shelf label depicted in the third region of the second image;
extracting a set of product data from the third region of the second image; and
in response to the set of product data corresponding to the second set of product data corresponding to the first product type, verifying updating of the first electronic shelf label according to the first notification.

9. The method of claim 8, further comprising, in response to the set of product data differing from the second set of product data:
flagging the first electronic shelf label for further investigation;
interpreting an error event associated with the first electronic shelf label;
generating a prompt to investigate the first electronic shelf label; and
transmitting the prompt to a computing device accessed by a store associate affiliated with the store.

10. The method of claim 1:
wherein transmitting the first notification to the first electronic shelf label comprises transmitting the first notification to the first electronic shelf label at a first time; and
further comprising:
accessing a second image of the inventory structure captured by the robotic system at a second time succeeding the first time;
detecting the first slot within the inventory structure in the second image;
detecting a second set of objects occupying the first slot in the second image;
extracting a third set of features from a first region of the second image representing the second set of objects;
based on the third set of features, identifying a second set of product units of a second product type occupying the first slot at the second time;
detecting a second object in a second lateral position in the second image, the second lateral position below the first slot;
extracting a fourth set of features from a second region of the second image representing the second object;
based on the fourth set of features, identifying the first electronic shelf label depicted in the second region of the second image; and
in response to the second product type corresponding to the target product type assigned to the first slot and in response to the second product type differing from the first product type advertised by the first electronic shelf label:
generating a second notification comprising the first set of product data corresponding to the target product type; and
transmitting the second notification to the first electronic shelf label for rendering within the electronic display of the first electronic shelf label.

11. The method of claim 1, wherein generating the first notification comprising the second set of product data comprises generating the first notification comprising:
the second set of product data;
a first command to render the second set of product data within a first subregion of the electronic display of the first electronic shelf label; and
a second command to render a first visual indicator within a second subregion of the electronic display, the first visual indicator configured to indicate replacement of product units of the target product type with product units of the first product in the first slot.

12. The method of claim 1, wherein accessing the target product type assigned to the first slot by the graphical representation of the store comprises accessing the target product type assigned to the first slot by the graphical representation of the store, the graphical representation comprising a planogram generated for the store.

13. A method comprising:
accessing an image of an inventory structure captured by a robotic system while navigating through a store at a first time, the inventory structure defining a set of slots;
detecting a first slot, in the set of slots, depicted in the image;
identifying a first electronic shelf label depicted in a first region of the image arranged below the first region;
extracting a first set of product data from the first region of the image, the first set of product data corresponding to a first product type and rendered within an electronic display of the first electronic shelf label at the first time;
accessing a target product type assigned to the first slot by a graphical representation of the store; and
in response to the first product type, advertised by the first electronic shelf label, differing from the target product type assigned to the first slot:
detecting a first set of product units occupying the first slot depicted in the image;
extracting a first set of features from a first region of the image corresponding to the first slot;
based on the first set of features, identifying a second product type of the first set of product units occupying the first slot; and
in response to the second product type corresponding to the target product type assigned to the first slot and in response to the second product type differing from the first product type advertised by the first electronic shelf label:
accessing a second set of product data from a product database defined for the store, the second set of product data corresponding to the target product type of the first set of product units occupying the first slot;
generating a first notification comprising the second set of product data; and
transmitting the first notification to the first electronic shelf label for rendering within the electronic display of the first electronic shelf label.

14. The method of claim 13, wherein identifying the first electronic shelf label comprises:
detecting a first object in a first lateral position in the image, the first lateral position below the first slot;
extracting a second set of features from a second region of the image representing the first object; and
based on the second set of features, identifying a first electronic shelf label depicted in the second region of the image.

15. The method of claim 13, further comprising, in response to the second product type differing from the target product type assigned to the first slot and in response to the second product type differing from the first product type advertised by the first electronic shelf label:
accessing a second set of product data from a product database defined for the store, the second set of product data corresponding to the first product type of the first set of product units occupying the first slot;
generating a second notification comprising the second set of product data; and
transmitting the second notification to the first electronic shelf label for rendering within the electronic display of the first electronic shelf label.

16. The method of claim 13, further comprising, in response to the second product type differing from the target product type assigned to the first slot and in response to the second product type corresponding to the first product type advertised by the first electronic shelf label:
generating a second notification comprising a prompt to reconcile the first slot and the graphical representation of the store; and
transmitting the second notification to a computing device accessed by a store associate affiliated with the store.

17. The method of claim 13, further comprising, in response to the first product type, advertised by the first electronic shelf label, corresponding to the target product type assigned to the first slot:
detecting the first set of product units occupying the first slot depicted in the image;
extracting the first set of features from a first region of the image corresponding to the first slot;
based on the first set of features, identifying the second product type of the first set of product units occupying the first slot;
in response to the second product type corresponding to the target product type assigned to the first slot and in response to the second product type corresponding to the first product type advertised by the first electronic shelf label, confirming verification of the first slot.

18. A method comprising:
accessing an image of an inventory structure captured by a robotic system while navigating through a store, the inventory structure defining a set of slots;
detecting a first slot, in the set of slots, within the inventory structure in the image;
detecting a first object in a first lateral position in the image, the first lateral position below the first slot;
extracting a second set of features from a second region of the image representing the first object;
based on a first set of features extracted from a first region of the image, detecting absence of product units occupying the first slot in the image, the first region representing the first slot;
based on the second set of features, identifying a first electronic shelf label depicted in the second region of the image; and
in response to detecting absence of product units occupying the first slot:
accessing a target product type assigned to the first slot by a graphical representation of the store;
accessing an inventory database defining stock conditions of a set of product types within the store; and
in response to the inventory database defining an out-of-stock condition for the target product type:
generating a first notification to re-stock the first slot with product units of a first product type in replacement of the target product type;
transmitting the first notification to a computing device accessed by a store associate affiliated with the store;
accessing a first set of product data from a product database of the store, the first set of product data associated with the first product type;
generating a second notification comprising the first set of product data; and
transmitting the second notification to the first electronic shelf label for rendering within an electronic display of the first electronic shelf label.

19. The method of claim 18, further comprising, in response to the inventory database specifying a first location, within the store, occupied by product units of the target product:
generating a third notification to restock the first slot with product units of the target product type from the first location;
transmitting the third notification to the computing device accessed by the store associate;
generating a fourth notification indicating the first location within the store; and
at a first time, transmitting the fourth notification to the first electronic shelf label to render on the electronic display for a first time window.

20. The method of claim 18:
wherein transmitting the second notification to the first electronic shelf label comprises transmitting the second notification to the first electronic shelf label at a first time; and
further comprising:
accessing a second image of the inventory structure captured by the robotic system while navigating through the store at a second time succeeding the first time;
detecting the first slot, in the set of slots in the inventory structure, depicted in the second image;
based on features extracted from the first region of the image, detecting presence of product units of the target product type occupying the first slot; and
in response to detecting presence of product units of the target product type occupying the first slot:
generating a second electronic notification indicating the first set of product data; and
transmitting the second electronic notification to the first electronic shelf label to render on the integrated display of the electronic shelf label.
